(19) United States
(12) Patent Application Publication
(10) Pub. No.: US 2014/0267617 A1
(43) Pub. Date: Sep. 18, 2014

(54) ADAPTIVE DEPTH SENSING

(71) Applicant: Scott A. Krig, Folsom, CA (US)

(72) Inventor: Scott A. Krig, Folsom, CA (US)

(21) Appl. No.: 13/844,504

(22) Filed: Mar. 15, 2013

(51) Int. Cl. H04N 13/02

(52) U.S. Cl. CPC H04N 13/0203
USPC 348/46

(57) ABSTRACT

An apparatus, system, and a method are described herein. The apparatus includes one or more sensors, wherein the sensors are coupled by a baseline rail. The apparatus also includes a controller device that is to move the one or more sensors along the baseline rail such that the baseline rail is to adjust a baseline between of each of the one or more sensors.

### TECHNICAL FIELD

The present invention relates generally to depth sensing. More specifically, the present invention relates to adaptive depth sensing at various depth planes.

### BACKGROUND ART

During image capture, there are various techniques used to capture depth information associated with the image information. The depth information is typically used to produce a representation of the depth contained within the image. The depth information may be in the form of a point cloud, a depth map, or a three dimensional (3D) polygonal mesh that may be used to indicate at the depth of 3D objects within the image. Depth information can be also be derived from two dimensional (2D) images using stereo pairs or multiview stereo reconstruction methods, and can also be derived from a wide range of direct depth sensing methods including structured light, time of flight sensors, and many other methods. The depth is captured a fixed depth resolution values at set depth planes.

### BRIEF DESCRIPTION OF THE DRAWINGS

FIG. 1 is a block diagram of a computing device that may be used to provide adaptive depth sensing;

FIG. 2 is an illustration of two depth fields with different baselines;

FIG. 3 is an illustration of an image sensor with a MEMS device;

FIG. 4 is an illustration of three dithering grids;

FIG. 5 is an illustration of the dither movements across a grid;

FIG. 6 is a diagram showing MEMS controlled sensors along a baseline rail;

FIG. 7 is a diagram illustrating the change in the field of view based on a change in the baseline between two sensors;

FIG. 8 is an illustration of a mobile device;

FIG. 9 is a process flow diagram of a method for adaptive depth sensing;

FIG. 10 is a block diagram of an exemplary system for providing adaptive depth sensing;

FIG. 11 is a schematic of a small form factor device in which the system of FIG. 10 may be embodied; and

FIG. 12 is a block diagram showing tangible, non-transitory computer-readable media 1200 that stores code for adaptive depth sensing.

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Depth and image sensors are largely are largely static, preset devices, capturing depth and images with fixed depth resolution values at various depth planes. The depth resolution values and the depth planes are fixed due to the preset optical field of view for the depth sensors, the fixed aperture of the sensors, and the fixed sensor resolution. Embodiments herein provide adaptive depth sensing. In some embodiments, the depth representation may be tuned based on a use of the depth map or an area of interest within the depth map. In some embodiments, adaptive depth sensing is scalable depth sensing based on the human visual system. The adaptive depth sensing may be implemented using a microelectromechanical system (MEMS) to adjust the aperture and the optical center field of view. The adaptive depth sensing may also include a set of dither patterns at various locations.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 that may be used to provide adaptive depth sensing. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The instructions that are executed by the CPU 102 may be used to implement adaptive depth sensing.

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100. In some embodiments, the GPU 108 includes a number of graphics engines (not shown), wherein each graphics engine is configured to perform specific graphics tasks, or to execute specific types of workloads. For example, the GPU 108 may include an engine that controls the dithering of a sensor. A graphics engine may also be used to control the aperture and the optical center of the field of view (FOV) in order to tune the depth resolution and the depth field linearity. In some embodiments, resolution is a measure of data points within a particular area. The data points can be depth information, image information, or any other data point measured by a sensor. Further, the resolution may include a combination of different types of data points.

The memory device 104 can include random access memory (RAM), read only memory (ROM), flash memory, or any other suitable memory systems. For example, the memory device 104 may include dynamic random access memory (DRAM). The memory device 104 includes drivers 110. The drivers 110 are configured to execute the instructions for the operation of various components within the computing device 100. The device driver 110 may be software, an application program, application code, or the like. The drivers may also be used to operate the GPU as well as control the dithering of a sensor, the aperture, and the optical center of the field of view (FOV).

The computing device 100 includes one or more image capture devices 112. In some embodiments, the image capture devices 112 can be a camera, stereoscopic camera, infrared sensor, or the like. The image capture devices 112 are used to capture image information and the corresponding depth information. The image capture devices 112 may include sensors 114 such as a depth sensor, RGB sensor, an image sensor, an infrared sensor, an X-Ray photon counting sensor, a light sensor, or any combination thereof. The image sensors may include charge-coupled device (CCD) image sensors, complementary metal-oxide-semiconductor (CMOS) image sensors, system on chip (SOC) image sensors, image sensors with photosensitive thin film transistors, or any combination thereof. In some embodiments, a sensor 114 is a depth sensor 114. The depth sensor 114 may be used to capture the depth information associated with the image information. In some embodiments, a driver 110 may be used to operate a sensor within the image capture device 112, such as a depth sensor. The depth sensors may perform adaptive depth sensing by adjusting the form of dithering, the aperture, or optical center of FOV observed by the sensors. A MEMS 115 may adjust the physical position between one or more sensors 114. In some embodiments, the MEMS 115 is used to adjust the position between two depth sensors 114.

The CPU 102 may be connected through the bus 106 to an input/output (I/O) device interface 116 configured to connect the computing device 100 to one or more I/O devices 118. The I/O devices 118 may include, for example, a keyboard and a pointing device, wherein the pointing device may include a touchpad or a touchscreen, among others. The I/O devices 118 may be built-in components of the computing device 100, or may be devices that are externally connected to the computing device 100.

The CPU 102 may also be linked through the bus 106 to a display interface 120 configured to connect the computing device 100 to a display device 122. The display device 122 may include a display screen that is a built-in component of the computing device 100. The display device 122 may also include a computer monitor, television, or projector, among others, that is externally connected to the computing device 100.

The computing device also includes a storage device 124. The storage device 124 is a physical memory such as a hard drive, an optical drive, a thumbdrive, an array of drives, or any combinations thereof. The storage device 124 may also include remote storage drives. The storage device 124 includes any number of applications 126 that are configured to run on the computing device 100. The applications 126 may be used to combine the media and graphics, including 3D stereo camera images and 3D graphics for stereo displays. In examples, an application 126 may be used to provide adaptive depth sensing.

The computing device 100 may also include a network interface controller (NIC) 128 may be configured to connect the computing device 100 through the bus 106 to a network 130. The network 130 may be a wide area network (WAN), local area network (LAN), or the Internet, among others.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

The adaptive depth sensing may vary in a manner similar to the human visual system, which includes two eyes. Each eye captures a different image when compared to the other eye due to the different positions of the eyes. The human eye captures images using the pupil, which is an opening in the center of the eye that is able to change size in response to the amount of light entering the pupil. The distance between each pupil may be referred to as a baseline. Images captured by a pair of human eyes are offset by this baseline distance. The offset images result in depth perception, as the brain can use information from the offset images to calculate the depths of objects within the field of view (FOV). In addition to using offset images to perceive depth, the human eye will also use saccadic movements to dither about the center of the FOV of a region of interest. Saccadic movements include rapid eye movements around center, or focal point, of the FOV. The saccadic movements further enable the human visual system to perceive depth.

FIG. 2 is an illustration of two depth fields with different baselines. The depth fields include a depth field 202 and a depth field 204. The depth field 202 is calculated using the information from three apertures. The aperture is a hole in the center of a lens of an image capture device, and can perform functions similar to the pupil of the human visual system. In examples, each of the aperture 206A, the aperture 206B, and the aperture 206C may form a portion of an image capture device, sensor, or any combinations thereof. In examples, the image capture device is a stereoscopic camera. The aperture 206A, the aperture 206B, and the aperture 206C are used to capture three offset images which can be used to perceive depth within the image. As illustrated, the depth field 202 has a highly variable granularity of depth throughout the depth field. Specifically, near the aperture 206A, the aperture 206B, and the aperture 206C, the depth perception in the depth field 202 is fine, as indicated by the smaller rectangular areas within the grid of the depth field 202. Furthest away from the aperture 206A, the aperture 206B, and the aperture 206C, the depth perception in the depth field 202 is course, as indicated by the larger rectangular areas within the grid of the depth field 202.

The depth field 204 is calculated using the information from eleven apertures. Each of the aperture 208A, the aperture 208B, the aperture 208C, the aperture 208D, the aperture 208E, the aperture 208F, the aperture 208G, the aperture 208H, the aperture 208I, the aperture 208, and the aperture 208K are used to provide eleven offset images. The images are used to calculate the depth field 204. Accordingly, the depth field 204 includes more images at various baseline locations when compared to the depth field 202. As a result, the depth field 204 has a more consistent representation of depth throughout the FOV with compared to the depth representation 202. The consistent representation of depth within the depth field 204 is indicated by the similar sized rectangular areas within the grid of the depth field depth field 202.

The depth field may refer to representations of depth information such as a point cloud, a depth map, or a three dimensional (3D) polygonal mesh that may be used to indicate the depth of 3D objects within the image. While the techniques are described herein using a depth field or depth map, any depth representation can be used. Depth maps of varying precision can be created using one or more MEMS devices to change the aperture size of the image capture device, as well as to change the optical center of the FOV. The depth maps of varying precision result in a scalable depth resolution. The MEMS device may also be used to dither the sensors and increase the frame rate for increased depth resolution. By dithering the sensors, a point within the area of the most dither may have an increased depth resolution when compared to an area with less dither.

MEMS controlled sensor accuracy dithering enables increased depth resolution using sub-sensor cell sized MEMS motion to increase resolution. In other words, the dithering motion can be smaller than the pixel size. In some embodiments, such dithering creates several sub-pixel data points to be captured for each pixel. For example, dithering the sensor by half-sensor cell increments in an X-Y plane enables for a set of four sub-pixel precision images to be created, where each of the four dithered frames could be used for sub-pixel resolution, integrated, or combined together to increase accuracy of the image.

The MEMS device may control aperture shape by adjusting the FOV for one or more image capture devices. For example, a narrow FOV may enable longer range depth sensing resolution, and a wider FOV may enable short range depth sensing. The MEMS device may also control the optical center of the FOV by enabling movement of one or more image capture devices, sensors, apertures, or any combination thereof. For example, the sensor baseline position can be widened to optimize the depth linearity for far depth resolution linearity, and the sensor baseline position can be shortened to optimize the depth perception for near range depth linearity.

FIG. 3 is an illustration 300 of a sensor 302 with a MEMS device 304. The sensor 302 may be a component of an image capture device. In some embodiments, the sensor 302 includes an aperture for capturing image information, depth information, or any combination thereof. The MEMS device 304 may be in contact with the sensor 302 such that the MEMS device 304 can move the sensor 302 throughout an X-Y plane. Accordingly, the MEMS device 304 can be used to move the sensor in four different directions, as indicated by arrow 306A, an arrow 306B, and arrow 306C, and an arrow 306D.

In some embodiments, a depth sensing module can incorporate a MEMS device 304 to rapidly dither the sensor 302 to mimic the human eye saccadic movements. In this manner, resolution of the image is provided at sub-photo diode cell granularity during the time when for the photo diode cells of the image sensor accumulate light. This is because multiple offset images provide data for a single photo cells at various offset positions. The depth resolution of an image that includes dithering of the image sensor may increase the depth resolution of the image. The dither mechanism is able to dither the sensor at a fraction of the photo diode size.

For example, the MEMS device 304 may be used to dither a sensor 302 in fractional amounts of the sensor cell size, such as 1 μm for each cell size dimension. The MEMS device 304 may dither the sensor 302 in the image plane to increase the depth resolution similar to human eye saccadic movements. In some embodiments, the sensor and a lens of the image capture device may move together. Further, in some embodiments, the sensor may move with the lens. In some embodiments, the sensor may move under the lens while the lens is stationary.

In some embodiments, variable saccadic dither patterns for the MEMS device can be designed or selected, resulting in a programmable saccadic dithering system. The offset images that are obtained using image dither can be captured in a particular in a sequence and then integrated together into a single, high resolution image.

FIG. 4 is an illustration of three dithering grids. The dithering grids include a dithering grid 402, a dithering grid 404, and a dithering grid 406. The dithering grid 402 is a three by three grid that includes a dither pattern that is centered around a center point of the three-by-three grid. The dither pattern travels around the edge of the grid in sequential order until stopping in the center. Similarly, the dithering grid 404 includes a dithering pattern that is centered around a center point in a three-by-three grid. However, the dither pattern travels from right, to left, to right across the dithering grid 404 in sequential order until stopping in lower right of the grid. In both the dithering grid 402 and the dithering grid 404 use a grid in which to total size of the grid is a fraction of the image sensor photo cell size. By dithering to obtain different views of fractions of photo cells, the depth resolution may be increased.

Dithering grid 406 uses an even finer grid resolution when compared to the dithering grid 402 and the dithering grid 404. The bold lines 408 represent the sensor image cell size. In some embodiments, the sensor image cell size is 1 μm for each cell. The thin lines 410 represent the fraction of the photo cell size captured as a result of a dithering interval.

FIG. 5 is an illustration 500 of the dither movements across a grid. The grid 502 may be a dithering grid 406 as described with respect to FIG. 4. Each dither results in an offset image 504 being captured. Specifically, each image 504A, 504B, 504C, 504D, 504E, 504F, 504G, 504, and 504I are offset from each other. Each dithered image 504A-504I is used to calculate a final image at reference number 506. As a result, the final image is able to use nine different images to calculate the resolution at the center of each dithered image. Areas of the image that are at or near the edge of the dithered images may have as few as one image up to nine different images to calculate the resolution of the image. By using dither, a higher resolution image when compared to using a fixed sensor position is obtained. The individual dithered images may be integrated together into the higher resolution image, and in an embodiment, may be used to increase depth resolution.

FIG. 6 is a diagram showing MEMS controlled sensors along a baseline rail 602. In addition to dithering the sensors, as discussed above, the sensors may also be moved along a baseline rail. In this manner, the depth sensing provided with the sensors is adaptive depth sensing. At reference number 600A, the sensor 604 and the sensor 606 move left or right along the baseline rail 602 in order to adjust a baseline 608 between the center of the sensor 604 and the center of the sensor 606. At reference number 600B, the sensor 602 and the sensor 606 have both moved to the right using the baseline rail 602 to adjust the baseline 608. In some embodiments, the MEMS device may be used to physically change the aperture region over the sensor. The MEMS device can change the location of the aperture through occluding portions of the sensor.

FIG. 7 is a diagram illustrating the change in the field of view and aperture based on a change in the baseline between two sensors. The rectangle of reference number 704 represents an area sensed by an aperture of the sensor 604 resulting from the baseline 706 and the sensor 606. The sensor 604 has a field of view 708, while the sensor 606 has a field of view 710. As a result of the baseline 706, the sensor 604 has an aperture at reference number 712 while sensor 606 has an aperture at reference number 714. In some embodiments, as a result of the length of the baseline, the optical center of the FOV is changed for each of the one or more sensors, which in turn changes the position of the aperture for each of the one or more sensors. In some embodiments, the optical center of the FOV and the aperture change position due to the overlapping FOV between one or more sensors. In some embodiments, the aperture may change as a result of a MEMS device changing the aperture. The MEMS device may occlude portions of the sensor to adjust the aperture. Further, in embodiments, a plurality of MEMS devices may be used to adjust the aperture and the optical center.

Similarly, the width of the aperture 720 for the sensor 604 is a result of the baseline 722 and with a field of view 724 for the sensor 604, and a field of view 726 for the sensor 606. As a result of the length of the baseline 722, the optical center of the FOV is changed for each of the sensor 604 and sensor 606, which in turn changes the position of the aperture for each of the sensor 604 and sensor 606. Specifically, sensor 604 has an aperture centered at reference number 728 while sensor 606 has an aperture at centered reference number 730. Accordingly, in some embodiments, the sensors 604 and 606 enable adaptive changes in the stereo depth field resolution. In embodiments, the adaptive changes in the stereo depth field can provide near field accuracy in the depth field as well as far field accuracy in the depth field.

In some embodiments, variable shutter masking enables a depth sensor to capture a depth map and image where desired. Various shapes are possible such as rectangles, polygons, circles and ellipse. Masking may be embodied in software to assemble the correct dimensions within the mask, or masking may be embodied an MEMS device which can change an aperture mask region over the sensor. A variable shutter mask allows for power savings as well as depth map size savings.

FIG. 8 is an illustration of a mobile device 800. The mobile device includes a sensor 802, a sensor 804 and a baseline rail 806. The baseline rail 806 may be used to change the length of the baseline 808 between the sensor 802 and the sensor 804. Although the sensor 802, the sensor 804, and the baseline rail 806 are illustrated in a “front facing” position of the device, the sensor 802, the sensor 804, and the baseline rail 806 may be in any position on the device 800.

FIG. 9 is a process flow diagram of a method for adaptive depth sensing. At block 902, a baseline between one or more sensors is adjusted. At block 904, one or more offset images is captured using each of the one or more sensors. At block 906, the one or more images is combined into a single image. At block 908, an adaptive depth field is calculated using depth information from the image.

Using the presently described techniques, depth sensing may include variable sensing positions within one device to enable adaptive depth sensing. The applications for using depth have access to more information as the depth planes may be varied according to the requirements of each application, resulting in an enhanced user experience. Further, by varying the depth field the resolution can be normalized, even within the depth field, which enables increased localized depth field resolution and linearity. Adaptive depth sensing also enables depth resolution and accuracy where on a per-application basis, which enables optimizations to support near and far depth use cases. Moreover, a single stereo system can be used to create a wider range of stereo depth resolution, which results in decreased costs and increased application suitability since the same depth sensor can provide scalable depth to support a wider range of use-cases with requirements varying over the depth field.

FIG. 10 is a block diagram of an exemplary system 1000 for providing adaptive depth sensing. Like numbered items are as described with respect to FIG. 1. In some embodiments, the system 1000 is a media system. In addition, the system 1000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, or the like.

In various embodiments, the system 1000 comprises a platform 1002 coupled to a display 1004. The platform 1002 may receive content from a content device, such as content services device(s) 1006 or content delivery device(s) 1008, or other similar content sources. A navigation controller 1010 including one or more navigation features may be used to interact with, for example, the platform 1002 and/or the display 1004. Each of these components is described in more detail below.

The platform 1002 may include any combination of a chipset 1012, a central processing unit (CPU) 102, a memory device 104, a storage device 124, a graphics subsystem 1014, applications 126, and a radio 1016. The chipset 1012 may provide intercommunication among the CPU 102, the memory device 104, the storage device 124, the graphics subsystem 1014, the applications 126, and the radio 1014. For example, the chipset 1012 may include a storage adapter (not shown) capable of providing intercommunication with the storage device 124.

The CPU 102 may be implemented as Complex Instruction Set Computer (CISC) or Reduced Instruction Set Computer (RISC) processors, x86 instruction set compatible processors, multi-core, or any other microprocessor or central processing unit (CPU). In some embodiments, the CPU 102 includes dual-core processor(s), dual-core mobile processor(s), or the like.

The memory device 104 may be implemented as a volatile memory device such as, but not limited to, a Random Access Memory (RAM), Dynamic Random Access Memory (DRAM), or Static RAM (SRAM). The storage device 124 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some embodiments, the storage device 124 includes technology to increase the storage performance enhanced protection for valuable digital media when multiple hard drives are included, for example.

The graphics subsystem 1014 may perform processing of images such as still or video for display. The graphics subsystem 1014 may include a graphics processing unit (GPU), such as the GPU 108, or a visual processing unit (VPU), for example. An analog or digital interface may be used to communicatively couple the graphics subsystem 1014 and the display 1004. For example, the interface may be any of a High-Definition Multimedia Interface, DisplayPort, wireless HDMI, and/or wireless HD compliant techniques. The graphics subsystem 1014 may be integrated into the CPU 102 or the chipset 1012. Alternatively, the graphics subsystem 1014 may be a stand-alone card communicatively coupled to the chipset 1012.

The graphics and/or video processing techniques described herein may be implemented in various hardware architectures. For example, graphics and/or video functionality may be integrated within the chipset 1012. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 1016 may include one or more radios capable of transmitting and receiving signals using various suitable wireless communications techniques. Such techniques may involve communications across one or more wireless networks. Exemplary wireless networks include wireless local area networks (WLANs), wireless personal area networks (WPANs), wireless metropolitan area network (WMANs), cellular networks, satellite networks, or the like. In communicating across such networks, the radio 1016 may operate in accordance with one or more applicable standards in any version.

The display 1004 may include any television type monitor or display. For example, the display 1004 may include a computer display screen, touch screen display, video monitor, television, or the like. The display 1004 may be digital and/or analog. In some embodiments, the display 1004 is a holographic display. Also, the display 1004 may be a transparent surface that may receive a visual projection. Such projections may convey various forms of information, images, objects, or the like. For example, such projections may be a visual overlay for a mobile augmented reality (MAR) application. Under the control of one or more applications 126, the platform 1002 may display a user interface 1018 on the display 1004.

The content services device(s) 1006 may be hosted by any national, international, or independent service and, thus, may be accessible to the platform 1002 via the Internet, for example. The content services device(s) 1006 may be coupled to the platform 1002 and/or to the display 1004. The platform 1002 and/or the content services device(s) 1006 may be coupled to a network 130 to communicate (e.g., send and/or receive) media information to and from the network 130. The content delivery device(s) 1008 also may be coupled to the platform 1002 and/or to the display 1004.

The content services device(s) 1006 may include a cable television box, personal computer, network, telephone, or Internet-enabled device capable of delivering digital information. In addition, the content services device(s) 1006 may include any other similar devices capable of unidirectionally or bidirectionally communicating content between content providers and the platform 1002 or the display 1004, via the network 130 or directly. It will be appreciated that the content may be communicated unidirectionally and/or bidirectionally to and from any one of the components in the system 1000 and a content provider via the network 130. Examples of content may include any media information including, for example, video, music, medical and gaming information, and so forth.

The content services device(s) 1006 may receive content such as cable television programming including media information, digital information, or other content. Examples of content providers may include any cable or satellite television or radio or Internet content providers, among others.

In some embodiments, the platform 1002 receives control signals from the navigation controller 1010, which includes one or more navigation features. The navigation features of the navigation controller 1010 may be used to interact with the user interface 1018, for example. The navigation controller 1010 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures. Physical gestures include but are not limited to facial expressions, facial movements, movement of various limbs, body movements, body language or any combination thereof. Such physical gestures can be recognized and translated into commands or instructions.

Movements of the navigation features of the navigation controller 1010 may be echoed on the display 1004 by movements of a pointer, cursor, focus ring, or other visual indicators displayed on the display 1004. For example, under the control of the applications 126, the navigation features located on the navigation controller 1010 may be mapped to virtual navigation features displayed on the user interface 1018. In some embodiments, the navigation controller 1010 may not be a separate component but, rather, may be integrated into the platform 1002 and/or the display 1004.

The system 1000 may include drivers (not shown) that include technology to enable users to instantly turn on and off the platform 1002 with the touch of a button after initial boot-up, when enabled, for example. Program logic may allow the platform 1002 to stream content to media adaptors or other content services device(s) 1006 or content delivery device(s) 1008 when the platform is turned “off.” In addition, the chipset 1012 may include hardware and/or software support for 5.1 surround sound audio and/or high definition 7.1 surround sound audio, for example. The drivers may include a graphics driver for integrated graphics platforms. In some embodiments, the graphics driver includes a peripheral component interconnect express (PCIe) graphics card.

In various embodiments, any one or more of the components shown in the system 1000 may be integrated. For example, the platform 1002 and the content services device(s) 1006 may be integrated; the platform 1002 and the content delivery device(s) 1008 may be integrated; or the platform 1002, the content services device(s) 1006, and the content delivery device(s) 1008 may be integrated. In some embodiments, the platform 1002 and the display 1004 are an integrated unit. The display 1004 and the content service device(s) 1006 may be integrated, or the display 1004 and the content delivery device(s) 1008 may be integrated, for example.

The system 1000 may be implemented as a wireless system or a wired system. When implemented as a wireless system, the system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum. When implemented as a wired system, the system 1000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, or the like. Examples of wired communications media may include a wire, cable, metal leads, printed circuit board (PCB), backplane, switch fabric, semiconductor material, twisted-pair wire, co-axial cable, fiber optics, or the like.

The platform 1002 may establish one or more logical or physical channels to communicate information. The information may include media information and control information. Media information may refer to any data representing content meant for a user. Examples of content may include, for example, data from a voice conversation, videoconference, streaming video, electronic mail (email) message, voice mail message, alphanumeric symbols, graphics, image, video, text, and the like. Data from a voice conversation may be, for example, speech information, silence periods, background noise, comfort noise, tones, and the like. Control information may refer to any data representing commands, instructions or control words meant for an automated system. For example, control information may be used to route media information through a system, or instruct a node to process the media information in a predetermined manner. The embodiments, however, are not limited to the elements or the context shown or described in FIG. 10.

FIG. 11 is a schematic of a small form factor device 1100 in which the system 1000 of FIG. 10 may be embodied. Like numbered items are as described with respect to FIG. 10. In some embodiments, for example, the device 1100 is implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and the like.

An example of a mobile computing device may also include a computer that is arranged to be worn by a person, such as a wrist computer, finger computer, ring computer, eyeglass computer, belt-clip computer, arm-band computer, shoe computer, clothing computer, or any other suitable type of wearable computer. For example, the mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well.

As shown in FIG. 11, the device 1100 may include a housing 1102, a display 1104, an input/output (I/O) device 1106, and an antenna 1108. The device 1100 may also include navigation features 1110. The display 1104 may include any suitable display unit for displaying information appropriate for a mobile computing device. The I/O device 1106 may include any suitable I/O device for entering information into a mobile computing device. For example, the I/O device 1106 may include an alphanumeric keyboard, a numeric keypad, a touch pad, input keys, buttons, switches, rocker switches, microphones, speakers, a voice recognition device and software, or the like. Information may also be entered into the device 1100 by way of microphone. Such information may be digitized by a voice recognition device.

In some embodiments, the small form factor device 1100 is a tablet device. In some embodiments, the tablet device includes an image capture mechanism, where the image capture mechanism is a camera, stereoscopic camera, infrared sensor, or the like. The image capture device may be used to capture image information, depth information, or any combination thereof. The tablet device may also include one or more sensors. For example, the sensors may be a depth sensor, an image sensor, an infrared sensor, an X-Ray photon counting sensor or any combination thereof. The image sensors may include charge-coupled device (CCD) image sensors, complementary metal-oxide-semiconductor (CMOS) image sensors, system on chip (SOC) image sensors, image sensors with photosensitive thin film transistors, or any combination thereof. In some embodiments, the small form factor device 1100 is a camera.

Furthermore, in some embodiments, the present techniques may be used with displays, such as television panels and computer monitors. Any size display can be used. In some embodiments, a display is used to render images and video that includes adaptive depth sensing. Moreover, in some embodiments, the display is a three dimensional display. In some embodiments, the display includes an image capture device to capture images using adaptive depth sensing. In some embodiments, an image device may capture images or video using adaptive depth sensing, including dithering one or more sensor and adjusting a baseline rail between the sensors, and then render the images or video to a user in real time.

Additionally, in embodiments, the computing device 100 or the system 1000 may include a print engine. The print engine can send an image to a printing device. The image may include a depth representation from an adaptive depth sensing module. The printing device can include printers, fax machines, and other printing devices that can print the resulting image using a print object module. In some embodiments, the print engine may send an adaptive depth representation to the printing device 136 across the network 132. In some embodiments, the printing device includes one or more sensors and a baseline rail for adaptive depth sensing.

FIG. 12 is a block diagram showing tangible, non-transitory computer-readable media 1200 that stores code for adaptive depth sensing. The tangible, non-transitory computer-readable media 1200 may be accessed by a processor 1202 over a computer bus 1204. Furthermore, the tangible, non-transitory computer-readable medium 1200 may include code configured to direct the processor 1202 to perform the methods described herein.

The various software components discussed herein may be stored on one or more tangible, non-transitory computer-readable media 1200, as indicated in FIG. 12. For example, a baseline module 1206 may be configured to modify a baseline between one or more sensors. In some embodiments, the baseline module may also dither the one or more sensors. A capture module 1208 may be configured to obtain one or more offset images using each of the one or more sensors. An adaptive depth sensing module 1210 may combine the one or more images into a single image. Additionally, in some embodiments, the adaptive depth sensing module may generate an adaptive depth field using depth information from the image.

The block diagram of FIG. 12 is not intended to indicate that the tangible, non-transitory computer-readable medium 1200 is to include all of the components shown in FIG. 12. Further, the tangible, non-transitory computer-readable medium 1200 may include any number of additional components not shown in FIG. 12, depending on the details of the specific implementation.

### Example 1

An apparatus is described herein. The apparatus includes one or more sensors, wherein the sensors are coupled by a baseline rail and a controller device that is to move the one or more sensors along the baseline rail such that the baseline rail is to adjust a baseline between of each of the one or more sensors.

The controller may adjust the baseline between each of the one or more sensors along the baseline rail in a manner that is to adjust the field of view for each of the one or more sensors. The controller may also adjust the baseline between each of the one or more sensors along the baseline rail in a manner that is to adjust an aperture for each of the one or more sensors. The controller may be microelectromechanical system. Additionally, the controller may be a linear motor. The controller may adjust the baseline between each of the one or more sensors along the baseline rail in a manner that is to eliminate occlusion in a field of view for each of the one or more sensors. The controller may dither each of the one or more sensors about an aperture of each of the one or more sensors. The dither may be variable saccadic dither. The depth resolution of a depth field may be adjusted based on the baseline between the one or more sensors. The sensors may be an image sensor, a depth sensor, or any combination thereof. The apparatus is a tablet device, a camera or a display. The one or more sensors may capture image or video data, wherein the image data includes depth information, and renders the image or video data on a display.

### Example 2

A system is described herein. The system includes a central processing unit (CPU) that is configured to execute stored instructions, a storage device that stores instructions, the storage device comprising processor executable code that. The processor executable codes, when executed by the CPU, is configured to obtain offset images from one or more sensors, wherein the sensors are coupled to a baseline rail, and combine the offset images into a single image, wherein the depth resolution of the image is adaptive based on a baseline distance between the sensors along the baseline rail.

The system may vary a baseline of the one or more sensors using the baseline rail. The system may include an image capture device that includes the one or more sensors. Additionally, the system may dither the one or more sensors. The dither may be variable saccadic dither.

### Example 3

A method is described herein. The method includes adjusting a baseline between one or more sensors, capturing one or more offset images using each of the one or more sensors, combining the one or more images into a single image, and calculating an adaptive depth field using depth information from the image.

The one or more sensors may be dithered to obtain sub-cell depth information. The sensors may be dithered using variable saccadic dither. A dither program may be selected to obtain a pattern of offset images, and the one or more sensors are dithered according to the dither program. The baseline may be widened to capture far depth resolution linearity. The baseline may be narrowed to capture near depth resolution linearity.

### Example 4

A tangible, non-transitory, computer-readable medium is described herein. The computer readable medium includes code to direct a processor to modify a baseline between one or more sensors, obtain one or more offset images using each of the one or more sensors, combine the one or more images into a single image, and generate an adaptive depth field using depth information from the image. The one or more sensors may be dithered to obtain sub-cell depth information.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus, comprising:
one or more sensors, wherein the sensors are coupled by a baseline rail;
a controller device that is to move the one or more sensors along the baseline rail such that the baseline rail is to adjust a baseline between of each of the one or more sensors.

2. The apparatus of claim 1, wherein the controller adjusts the baseline between each of the one or more sensors along the baseline rail in a manner that is to adjust the field of view for each of the one or more sensors.

2. The apparatus of claim 1, wherein the controller adjusts the baseline between each of the one or more sensors along the baseline rail in a manner that is to adjust an aperture for each of the one or more sensors.

3. The apparatus of claim 1, wherein the controller is microelectromechanical system.

4. The apparatus of claim 1, wherein the controller is a linear motor.

5. The apparatus of claim 1, wherein the controller adjusts the baseline between each of the one or more sensors along the baseline rail in a manner that is to eliminate occlusion in a field of view for each of the one or more sensors.

6. The apparatus of claim 1, wherein the controller is to dither each of the one or more sensors about an aperture of each of the one or more sensors.

7. The apparatus of claim 6, wherein the dither is variable saccadic dither.

8. The apparatus of claim 1, wherein the depth resolution of a depth field is adjusted based on the baseline between the one or more sensors.

9. The apparatus of claim 1, wherein the sensors are an image sensor, a depth sensor, or any combination thereof.

10. The apparatus of claim 1, wherein the apparatus is a tablet device.

11. The apparatus of claim 1, wherein the apparatus is a camera.

12. The apparatus of claim 1, wherein the apparatus is a display.

13. The apparatus of claim 1, wherein the one or more sensors captures image or video data, wherein the image data includes depth information, and renders the image or video data on a display.

14. A system comprising:
a central processing unit (CPU) that is configured to execute stored instructions;
a storage device that stores instructions, the storage device comprising processor executable code that, when executed by the CPU, is configured to:
obtain offset images from one or more sensors, wherein the sensors are coupled to a baseline rail; and
combine the offset images into a single image, wherein the depth resolution of the image is adaptive based on a baseline distance between the sensors along the baseline rail.

15. The system of claim 14, wherein the system is to vary a baseline of the one or more sensors using the baseline rail.

16. The system of claim 14, further comprising an image capture device that includes the one or more sensors.

17. The system of claim 14, wherein the system is to dither the one or more sensors.

18. The system of claim 14, wherein the dither is variable saccadic dither.

19. A method, comprising:
adjusting a baseline between one or more sensors;
capturing one or more offset images using each of the one or more sensors;
combining the one or more images into a single image; and
calculating an adaptive depth field using depth information from the image.

20. The method of claim 19, the one or more sensors are dithered to obtain sub-cell depth information.

21. The method of claim 20, wherein the sensors are dithered using variable saccadic dither.

22. The method of claim 19, wherein a dither program is selected to obtain a pattern of offset images, and the one or more sensors are dithered according to the dither program.

23. The method of claim 19, wherein the baseline is widened to capture far depth resolution linearity.

24. The method of claim 19, wherein the baseline is narrowed to capture near depth resolution linearity.

25. A tangible, non-transitory, computer-readable medium comprising code to direct a processor to:
modify a baseline between one or more sensors;
obtain one or more offset images using each of the one or more sensors;
combine the one or more images into a single image; and
generate an adaptive depth field using depth information from the image.

26. The computer readable medium of claim 25, wherein the one or more sensors are dithered to obtain sub-cell depth information.
